(19) United States
(12) Patent Application Publication
(10) Pub. No.: US 2021/0347519 A1
(43) Pub. Date: Nov. 11, 2021

(54) BOX OPENING

(71) Applicant: WestRock Packaging Systems, LLC, Atlanta, GA (US)

(72) Inventor: Jean-Michel Garnier, Issoudun (FR)

(73) Assignee: WestRock Packaging Systems, LLC, Atlanta, GA (US)

(21) Appl. No.: 17/265,305

(22) PCT Filed: Jul. 19, 2019
(86) PCT No.: PCT/US2019/042502

§ 371 Date: Feb. 2, 2021

Related U.S. Application Data
(60) Provisional application No. 62/713,654, filed on Aug. 2, 2018.

(51) Int. Cl. B65D 5/02

(52) U.S. Cl. CPC B65D 5/0236; B31B 2120/302

(57) ABSTRACT

A box includes a plurality of side panels formed around an interior space. A pair of opposed outer flaps is foldably connected to two of the respective side panels, wherein the outer flaps are secured in a closed position to enclose one side of the box. A pair of opposed inner flaps are included, wherein the outer flaps overlie the inner flaps. A first one of the side panels of the box includes a pair of guide holes each configured to receive a respective opening guide for opening the outer flaps.

### BACKGROUND OF THE INVENTION

### 1. Field of the Invention

The present disclosure relates to packaging, and more particularly to opening boxes for flattening.

### 2. Description of Related Art

Packaging products, e.g., for shipping, utilizes a considerable amount of boxes. After use, it is often desirable to flatten the used box for recycling or for palletization for reuse. Breaking down boxes for flattening can be a large volume proposition, but can be a challenge for automation as the box must be opened and the flaps must be arranged properly before the box can be flattened.

The conventional techniques have been considered satisfactory for their intended purpose. However, there is an ever present need for improved systems and methods for box opening and flattening. This disclosure provides a solution for this need.

### SUMMARY OF THE INVENTION

A box includes a plurality of side panels formed around an interior space. A pair of opposed outer flaps is foldably connected to two of the respective side panels, wherein the outer flaps are secured in a closed position to enclose one side of the box. A pair of opposed inner flaps are included, wherein the outer flaps overlie the inner flaps. A first one of the side panels of the box includes a pair of guide holes each configured to receive a respective opening guide for opening the outer flaps.

Each guide hole can be partly defined in the first one of the side panels and can be partly defined in a first one of the inner flaps that is foldably connected to the first one of the side panels. The inner flaps can be biased by shape memory to open upon opening of the outer flaps. A respective fold line can connect each respective inner flap to a respective one of the side panels, wherein the shape memory is within the respective fold line to bias the inner flaps to open. Adhesive tape can secure the outer flaps in the closed position. The box can be configured so the side panels can collapse in parallelogram motion with the outer and inner flaps open. The inner flaps can each include an inner edge, wherein the inner edges conform to one another along a path that includes at least one change in direction.

A blank for a box includes a plurality of side panels connected along fold lines for forming the side panels around an interior space. A pair of opposed outer flaps are foldably connected to two of the respective side panels. The outer flaps are configured to be secured in a closed position to enclose one side of the box. A pair of opposed inner flaps are foldably connected to two of the respective side panels. The outer flaps are configured overlie the inner flaps. A first one of the side panels of the box includes a pair of guide holes each configured to receive a respective opening guide for opening the outer flaps.

Each guide hole can be partly defined in the first one of the side panels and can be partly defined in a first one of the inner flaps that is foldably connected to the first one of the side panels. The inner flaps can be biased by shape memory to open upon opening of the outer flaps. A respective fold line can connect each respective inner flap to a respective one of the side panels, wherein the shape memory is within the respective fold line to bias the inner flaps to open.

The side panels, inner flaps, and outer flaps can be configured so in a box formed from the blank the side panels can collapse in parallelogram motion with the outer and inner flaps open. The inner flaps can each include an inner edge, wherein the inner edges are configured to conform to one another along a path that includes at least one change in direction.

A method of processing boxes includes shuttling a box in a first direction wherein outer flaps of the box overlie inner flaps of the box. The method includes engaging a set of opening guides with the outer flaps through a pair of guide holes in a side end panel of the box to drive the outer flaps open. Collapsing the side panels in parallelogram motion with the outer and inner flaps open to flatten the box.

The method can include opening the inner flaps using shape memory. Opening the inner flaps using shape memory can include using shape memory within a respective fold line connecting each respective inner flap to the box, wherein the shape memory biases the inner flaps to open. The method can include cutting to separate the outer flaps from one another prior to engaging the opening guides, wherein cutting includes cutting adhesive tape along a cut line parallel to the first direction to release the outer flaps from one another.

The opening guides can be in a retracted position for cutting to separate the outer flaps, and the method can include extending the opening guides after cutting, engaging a respective guide hole in an end of the box with a respective one of the opening guides, and retracting the opening guides to the retracted position to drive the outer flaps open. At least one linear actuator mounted to the opening guides can move the opening guides from the retracted position to the extended position and vice versa.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 is a plan view of an exemplary embodiment of a blank constructed in accordance with the present disclosure, showing the side panels, inner flaps, and outer flaps;

FIG. 2 is a perspective view of a box formed from the blank of FIG. 1, showing the open end of the box;

FIG. 3 is a perspective view of the box of FIG. 2, showing the guide holes as viewed from inside the box;

FIG. 4 is schematic perspective view of the box of FIG. 2, showing the box being aligned with opening guides;

FIG. 5 is a schematic perspective view of the box of FIG. 2, showing the box being engaged with the opening guides;

FIGS. 6-8 is a schematic perspective views of the box of FIG. 2, showing the outer flaps opening at three stages of opening;

FIG. 9 is a schematic perspective view of the box of FIG. 2, showing two stages of the box being flattened in a parallelogram motion; and

FIG. 10 is a schematic perspective view of the box of FIG. 2, showing the box after flattening.

### DETAILED DESCRIPTION OF THE PREFERRED EMBODIMENTS

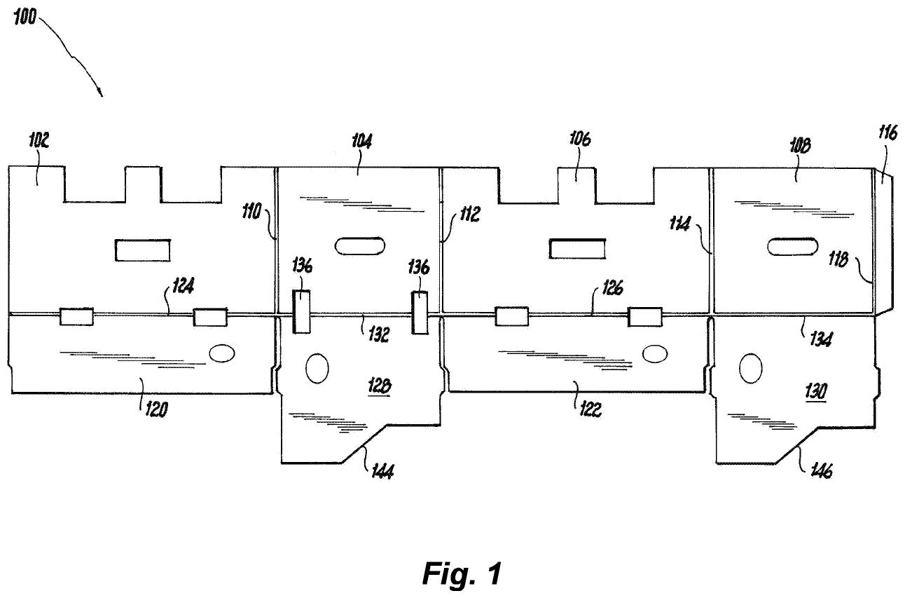

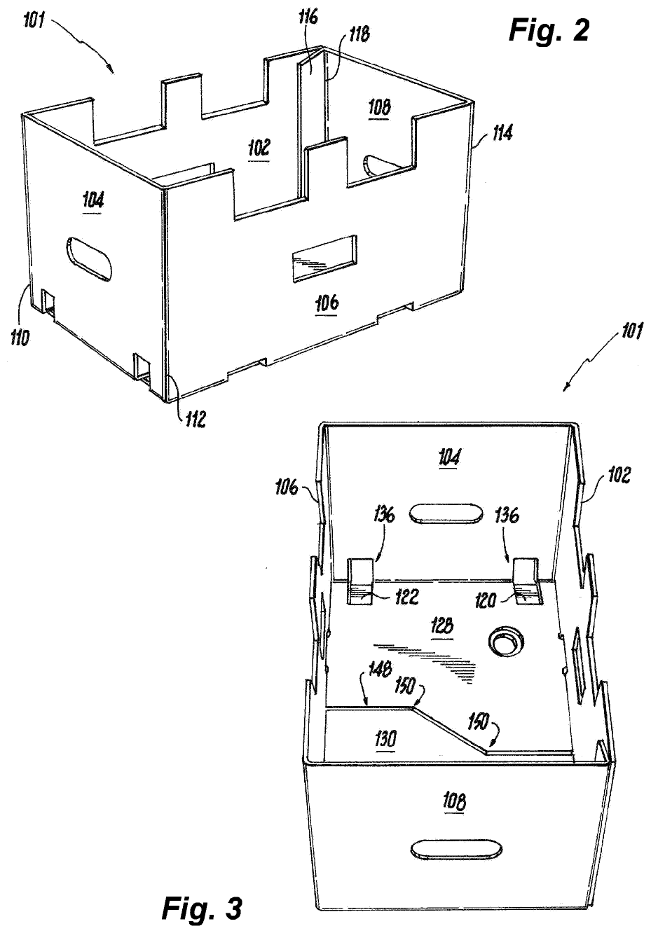

Reference will now be made to the drawings wherein like reference numerals identify similar structural features or aspects of the subject disclosure. For purposes of explanation and illustration, and not limitation, a partial view of an exemplary embodiment of a blank for box in accordance with the disclosure is shown in FIG. 1 and is designated generally by reference character 100. Other embodiments of boxes in accordance with the disclosure, or aspects thereof, are provided in FIGS. 2-10, as will be described. The systems and methods described herein can be used to process boxes, e.g. to facilitate flattening empty boxes.

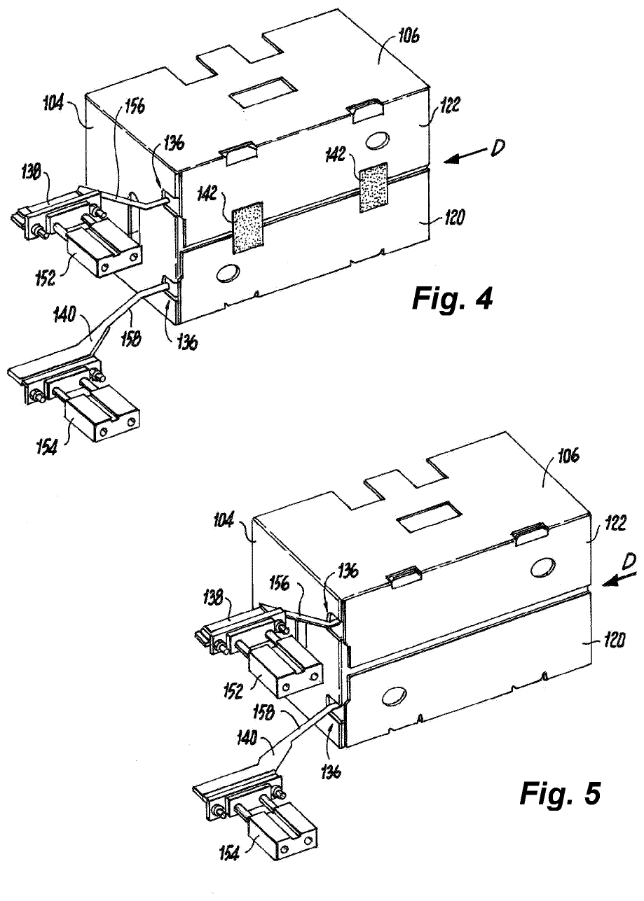

The blank 100 for a box 101 (the box 101 is shown in FIGS. 2-3) includes a plurality of side panels 102, 104, 106, 108 connected along respective fold lines 110, 112, 114 for forming the side panels 102, 104, 106, 108 around an interior space. An adhesive flap 116 is connected to side panel 108 by a fold line 118 for adhering to the edge of side panel 102 as shown in FIG. 2. A pair of opposed outer flaps 120, 122 are foldably connected along respective fold lines 124, 126 to two of the respective side panels 102, 106. The outer flaps 120, 122 are configured to be secured in a closed position to enclose one side of the box 101, e.g., the bottom of the box as oriented in FIG. 2. A pair of opposed inner flaps 128, 130 are foldably connected along respective fold lines 132, 134 to two of the respective side panels 104, 108. The outer flaps 120, 122 are configured overlie the inner flaps 128, 130. A first one of the side panels of the box, namely side panel 104, includes a pair of guide holes 136 each configured to receive a respective opening guide 138, 140 for opening the outer flaps 120, 122 as shown in FIG. 4. Each guide hole 136 is partly defined in the side panel 104 and is partly defined in a the inner flap 128. In other words, the guide holes 136 each span across the fold line 132 connecting the inner flap 128 to the side panel 104. The inner flaps 128, 130 are biased by shape memory to open upon opening of the outer flaps 120, 122, i.e., the inner flaps 128, 130 are biased by shape memory in the fold lines 132, 134 to return the inner flaps 128, 130 to the position in FIG. 1.

With reference to FIGS. 1 and 2, to form the box 101 from the blank 100, the blank 100 can be folded on fold lines 110, 112, 114, and 118. The adhesive flap 116 can be adhered to the edge of the side panel 102 as shown in FIG. 2. The inner flaps 128, 130 can be folded upwards along fold lines 132, 134, and then the outer flaps 120, 122 can be folded upward along fold lines 124, 126 (as oriented in FIG. 2). The outer flaps 120, 122 can be secured to one another using adhesive tape 142 (as shown in FIG. 4).

With reference to FIG. 3, when the box 101 is formed from the blank 100, each of the guide holes 136 is open along the side panel 104, and is partially covered along the bottom of the box (as oriented in FIG. 2) by the respective outer flap 120, 122. The inner flaps 128, 130 each include an inner edge 144, 146 (labeled in FIG. 1), wherein the inner edges 144, 146 are configured to conform to one another along a path 148 that includes at least one change in direction, e.g., at corner points 150.

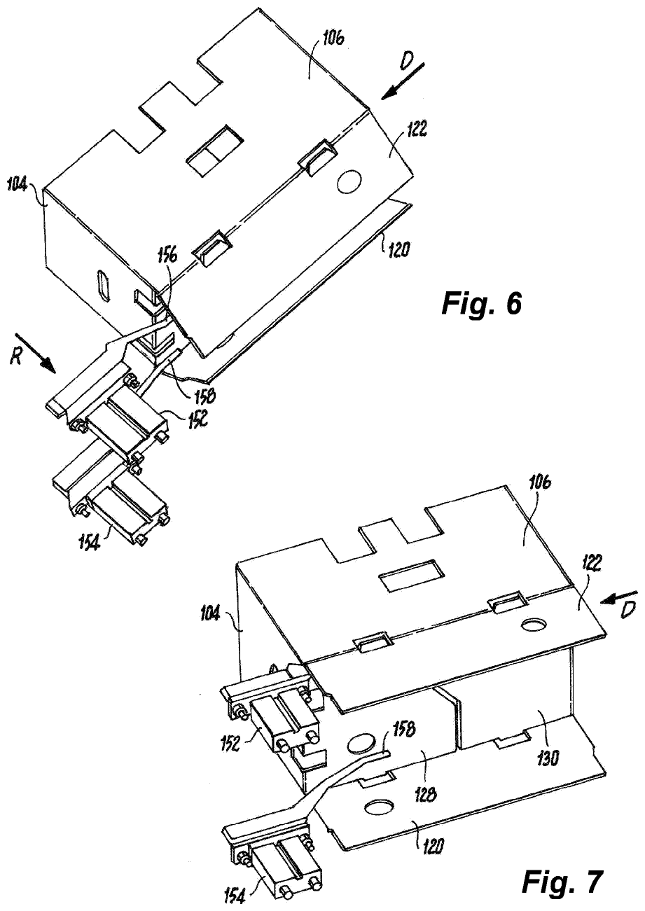

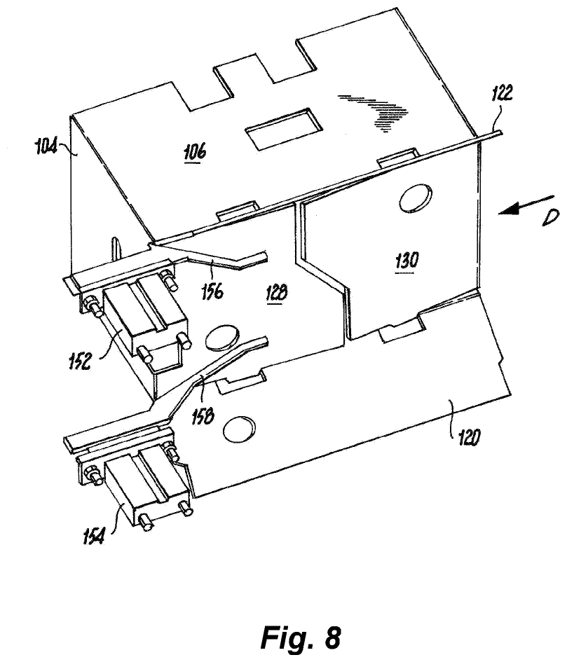

With reference now to FIG. 4, a method of processing boxes includes cutting the adhesive tape 142, e.g., along the line between outer flaps 120, 122, to separate the outer flaps 120, 122 from one another. Then the box 100 can be shuttled in a first direction D parallel with the line separating between the outer flaps 120, 122. The method includes engaging a set of opening guides 138, 140 with the outer flaps 120, 122 through the guide holes 136 to drive the outer flaps 120, 122 open. FIG. 4 shows the alignment of the opening guides 138, 140 with the respective guide holes 136. FIG. 5 shows the box 101 advancing in the direction D so that the ends of the opening guides 138, 140 pass into the guide holes 136. The opening guides 138, 140 are in a retracted position for cutting to separate the outer flaps 120, 122. Then, as shown in FIG. 6, the linear actuators 152, 154 retract the opening guides 138, 140 in a direction R perpendicular to the direction D of the travel of the box 101. The contact of the ends of the opening guides 138, 140 with the portion of the outer flaps 120, 122 that overlie the holes 136 (as shown in FIG. 3) allows the opening guides 138, 140 to pull the outer flaps 120, 122 open. Then, as shown in FIGS. 7-8, the ramped portions 156, 158 of the opening guides 138, 140 drive the outer flaps 120, 122 open even further. The linear actuators 152, 154 mounted to the opening guides 138, 140 move the opening guides 152, 154 from the retracted position to the extended position and vice versa.

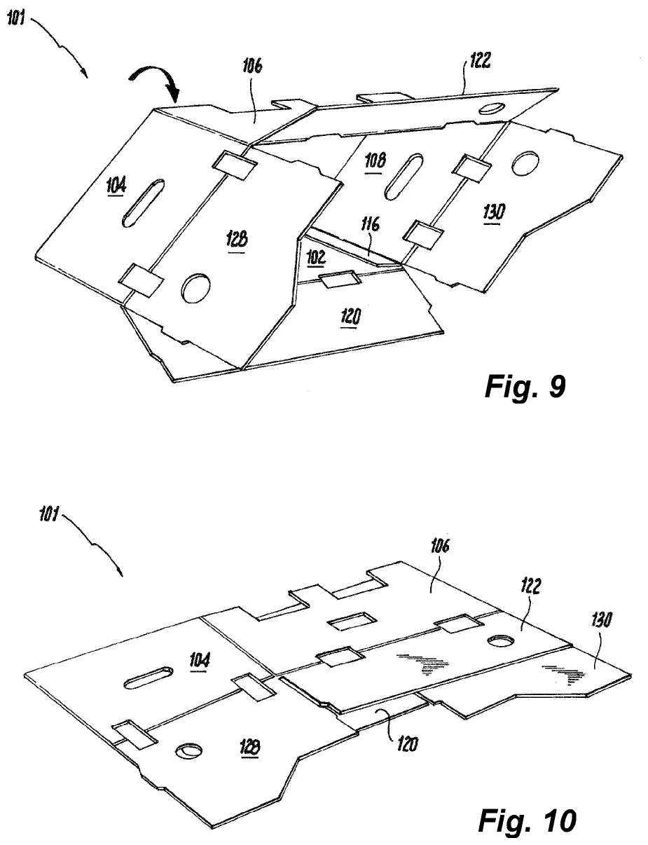

Thereafter, the shape memory in the fold lines 132, 134 (labeled in FIG. 1) open the inner flaps 128, 130 as in FIG. 9. FIG. 9 also shows collapsing the side panels 102, 104, 106, 108 in parallelogram motion (as indicated with the opposed arrows in FIG. 9) with the outer and inner flaps 120, 122, 128, 130 open to flatten the box 100 as shown in FIG. 10. If it is ever desired to use a box 101 with a different width from what is shown in FIGS. 4-9, i.e., where the box as oriented in FIG. 4 is taller, the guide holes 136 may be further apart from one another than shown in FIG. 4. Therefore, a vertical repositioning of one or both of the opening guides 138, 140 (as oriented in FIG. 4) can accommodate the change in box width, and the box opening procedure described above can be carried out in the same manner regardless of how wide the box 101 is.

The methods and systems of the present disclosure, as described above and shown in the drawings, provide for processing boxes with superior properties including opening and flattening the boxes with improved facility over traditional techniques. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A box comprising:
a plurality of side panels formed around an interior space;
a pair of opposed outer flaps foldably connected to two of the respective side panels, wherein the outer flaps are secured in a closed position to enclose one side of the box; and
a pair of opposed inner flaps, wherein the outer flaps overlie the inner flaps, wherein a first one of the side panels of the box includes a pair of guide holes each configured to receive a respective opening guide for opening the outer flaps.

2. The box as recited in claim 1, wherein each guide hole is partly defined in the first one of the side panels and is partly defined in a first one of the inner flaps that is foldably connected to the first one of the side panels.

3. The box as recited in claim 1, wherein the inner flaps are biased by shape memory to open upon opening of the outer flaps.

4. The box as recited in claim 3, wherein a respective fold line connects each respective inner flap to a respective one of the side panels, wherein the shape memory is within the respective fold line to bias the inner flaps to open.

5. The box as recited in claim 1, further comprising adhesive tape securing the outer flaps in the closed position.

6. The box as recited in claim 1, wherein the box is configured so the side panels can collapse in parallelogram motion with the outer and inner flaps open.

7. The box as recited in claim 1, wherein the inner flaps each include an inner edge, wherein the inner edges conform to one another along a path that includes at least one change in direction.

8. A blank for a box comprising:
a plurality of side panels connected along fold lines for forming the side panels around an interior space;
a pair of opposed outer flaps foldably connected to two of the respective side panels, wherein the outer flaps are configured to be secured in a closed position to enclose one side of the box; and
a pair of opposed inner flaps foldably connected to two of the respective side panels, wherein the outer flaps are configured overlie the inner flaps, wherein a first one of the side panels of the box includes a pair of guide holes each configured to receive a respective opening guide for opening the outer flaps.

9. The blank as recited in claim 8, wherein each guide hole is partly defined in the first one of the side panels and is partly defined in a first one of the inner flaps that is foldably connected to the first one of the side panels.

10. The blank as recited in claim 8, wherein the inner flaps are biased by shape memory to open upon opening of the outer flaps.

11. The blank as recited in claim 10, wherein a respective fold line connects each respective inner flap to a respective one of the side panels, wherein the shape memory is within the respective fold line to bias the inner flaps to open.

12. The blank as recited in claim 8, wherein the side panels, inner flaps, and outer flaps are configured so in a box formed from the blank the side panels can collapse in parallelogram motion with the outer and inner flaps open.

13. The blank as recited in claim 8, wherein the inner flaps each include an inner edge, wherein the inner edges are configured to conform to one another along a path that includes at least one change in direction.

14. A method of processing boxes comprising:
shuttling a box in a first direction wherein outer flaps of the box overlie inner flaps of the box;
engaging a set of opening guides with the outer flaps through a pair of guide holes in a side end panel of the box to drive the outer flaps open; and
collapsing the side panels in parallelogram motion with the outer and inner flaps open to flatten the box.

15. The method as recited in claim 14, further comprising opening the inner flaps using shape memory.

16. The method as recited in claim 15, wherein opening the inner flaps using shape memory includes using shape memory within a respective fold line connecting each respective inner flap to the box, wherein the shape memory biases the inner flaps to open.

17. The method as recited in claim 16, further comprising cutting to separate the outer flaps from one another prior to engaging the opening guides, wherein cutting includes cutting adhesive tape along a cut line parallel to the first direction to release the outer flaps from one another.

18. The method as recited in claim 17, wherein the opening guides are in a retracted position for cutting to separate the outer flaps, and further comprising:
extending the opening guides after cutting;
engaging a respective guide hole in an end of the box with a respective one of the opening guides; and
retracting the opening guides to the retracted position to drive the outer flaps open.

19. The method as recited in claim 18, wherein at least one linear actuator mounted to the opening guides moves the opening guides from the retracted position to the extended position and vice versa.
